(19) United States
(12) Patent Application Publication
(10) Pub. No.: US 2009/0080858 A1
(43) Pub. Date: Mar. 26, 2009

(54) IMAGE AND SOUND RECORDING/REPRODUCING DEVICE

(76) Inventors: Takashi Akiyama, Osaka (JP); Yuji Tanikawa, Osaka (JP); Hiroshi Imanishi, Osaka (JP)

Correspondence Address: MCDERMOTT WILL & EMERY LLP, 600 13TH STREET, NW, WASHINGTON, DC, 20005-3096, US

(21) Appl. No.: 11/917,841

(22) PCT Filed: May 10, 2006
(86) PCT No.: PCT/JP2006/309381

§ 371 Date: Dec. 17, 2007

(51) Int. Cl. H04N 5/91

(52) U.S. Cl. 386/92; 386/E05.003

(57) ABSTRACT

A plurality of LSIs (17, 27, 37) having the same configuration are linked in a chain, each of which includes at least an encoding section (12, 22, 32), a decoding section (16, 26, 36), a data transfer control section (13, 23, 33), a first bus (14, 24, 34) and a second bus (15, 25, 35). Disk drives (2a, 2b) are also connected to the link. Each unit circuit including each of the LSIs (17, 27, 37) has one-program recording function, and thus simultaneous recording of a plurality of programs onto the disk drives (2a, 2b) is attained.

### TECHNICAL FIELD

The present invention relates to a video/audio recording/playback apparatus permitting simultaneous recording of a plurality of programs.

### BACKGROUND ART

In recording of video/audio data of a received broadcast program on a disk medium, video and audio signals are generally compressed with an encoding section. In playback thereof, a decoding section is operated to decompress the signals.

In some conventional technology, to ensure execution of normal recording/playback operation even during dubbing from a hard disk to a DVD (digital versatile disk), a second decoding section and a second encoding section are provided for dubbing, in addition to a first encoding section for recording and a first decoding section for playback. If no dubbing is made, the first and second encoding sections can be operated in parallel to attain two-program simultaneous recording. Moreover, with further use of the first decoding section, another program can be played back while two-program simultaneous recording is underway (see Patent Literature 1).

### Patent Literature 1: Japanese Laid-Open Patent Publication No. 2003-224813

### DISCLOSURE OF THE INVENTION

### Problem to be Solved by the Invention

The conventional technology described above lacks in extensibility to simultaneous recording of three or more programs.

An object of the present invention is providing a video/audio recording/playback apparatus capable of easily increasing the number of programs that can be recorded simultaneously.

### Means for Solving the Problem

To attain the above object, the video/audio recording/playback apparatus of the pre-sent invention adopts a configuration in which a plurality of unit circuits each having an encoding section and a decoding section are linked in a chain.

To state specifically, the video/audio recording/playback apparatus of the present invention includes a disk drive for recording video/audio data and a plurality of unit circuits, each of the plurality of unit circuits including: first and second buses for transfer of video/audio data; an encoding section for encoding a video/audio signal to video/audio data; a decoding section for decoding video/audio data to a video/audio signal; and a data transfer control section responsible for reception of video/audio data from the encoding section, transmission of video/audio data to the decoding section, transfer of video/audio data using the first bus, and transfer of video/audio data using the second bus, wherein, to link the plurality of unit circuits in a chain, the first bus of one of two unit circuits adjacent to each other is linked to the second bus of the other unit circuit, and the disk drive is connected to one of the first and second buses of the plurality of unit circuits.

### EFFECT OF THE INVENTION

According to the present invention, a video/audio recording/playback apparatus capable of easily increasing the number of programs that can be recorded simultaneously is provided by linking a plurality of unit circuits each having one-program recording function in a chain.

### BRIEF DESCRIPTION OF THE DRAWINGS

FIG. 1 is a block diagram showing an exemplary configuration of the video/audio recording/playback apparatus of the present invention.

FIG. 2 is a block diagram showing another exemplary configuration of the video/audio recording/playback apparatus of the present invention.

FIG. 3 is a block diagram showing a detailed exemplary configuration of first, second and third data transfer control sections in FIGS. 1 and 2.

### DESCRIPTION OF REFERENCE NUMERALS

1 Antenna
2a, 2b Disk drive
10, 20, 30 Tuner
11, 21, 31 AD conversion section
12, 22, 32 Encoding section
13, 23, 33 Data transfer control section
14, 24, 34 First bus
15, 25, 35 Second bus
16, 26, 36 Decoding section
17, 27, 37 LSI
18, 28, 38 DA conversion section
101 Data transfer control section
102 Receiver part
103 First bus
104 Second bus
105 First transmitter/receiver part
106 Second transmitter/receiver part
107 First selection part
108 Second selection part
109 Control part
110 Third selection part
111 Transmitter part
201 Host function portion
202 Device function portion
203 Output selection portion
204 Input selection portion
205 Input/output selection portion
401, 501 First link bus
402, 502 Second link bus

### BEST MODE FOR CARRYING OUT THE INVENTION

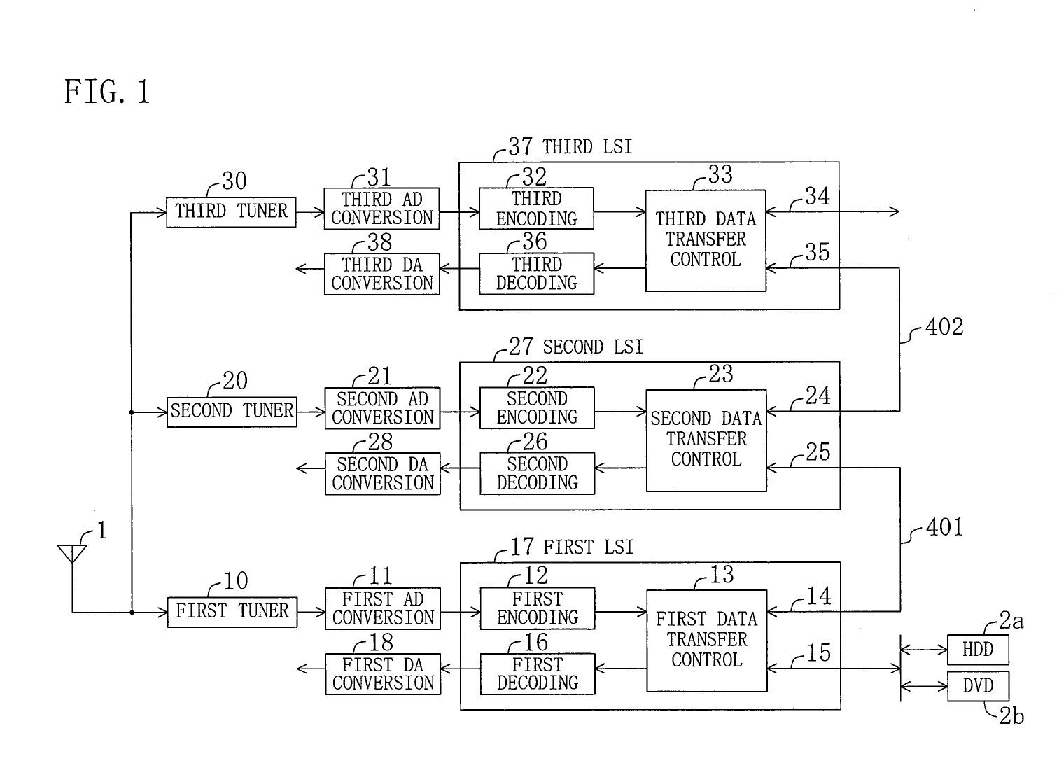

Hereinafter, embodiments of the present invention will be described with reference to FIGS. 1 to 3. In the following description, it is assumed that the interface between a host system and a plurality of memory devices is implemented according to an ANSI (American National Standards Institute) standard called ATA/ATAPI (AT Attachment with Packet Interface). Note that one host and two devices are connectable to one ATA/ATAPI interface bus.

FIG. 1 shows an exemplary configuration of the video/audio recording/playback apparatus of the present invention. The video/audio recording/playback apparatus of FIG. 1 includes first, second and third unit circuits each having a function of recording one program, placed between an antenna 1 for receiving a broadcast wave containing video/audio information and first and second disk drive 2a and 2b each for recording video/audio data. For example, the first disk drive 2a is a hard disk drive (HDD) and the second disk drive 2b is a DVD drive.

The first unit circuit includes a first tuner 10, a first analog-to-digital (AD) conversion section 11, a first encoding section 12, a first data transfer control section 13, a first bus 14, a second bus 15, a first decoding section 16 and a first digital-to-analog (DA) conversion section 18. The first encoding section 12, the first data transfer control section 13 and the first decoding section 16 constitute a first LSI (large-scale integrated circuit) 17.

The first tuner 10 selects a specific program from the information received by the antenna 1 and outputs an analog video/audio signal. The first AD conversion section 11 converts the analog video/audio signal received from the first tuner 10 to a digital video/audio signal, and outputs the converted signal to the first encoding section 12. The first encoding section 12 is responsible for compression to encode the digital video/audio signal received from the first AD conversion section 11 into video/audio data. The first data transfer control section 13 is responsible for reception of video/audio data from the first encoding section 12, transmission of video/audio data to the first decoding section 16, transfer of video/audio data using the first bus 14, transfer of video/audio data using the second bus 15, and entire control of the first LSI 17. The first and second buses 14 and 15 are ATA/ATAPI interface buses for transfer of video/audio data. The first decoding section 16 is responsible for decompression to decode video/audio data received from the first data transfer control section 13 into digital video/audio signals. The first DA conversion section 18 converts a digital video/audio signal received from the first decoding section 16 to an analog video/audio signal.

The second unit circuit has substantially the same configuration as the first unit circuit. The reference numeral 20 denotes a second tuner, 21 a second AD conversion section, 22 a second encoding section, 23 a second data transfer control section, 24 a first bus, 25 a second bus, 26 a second decoding section, 27 a second LSI, and 28 a second DA conversion section.

The third unit circuit has substantially the same configuration as the first and second unit circuits. The reference numeral 30 denotes a third tuner, 31 a third AD conversion section, 32 a third encoding section, 33 a third data transfer control section, 34 a first bus, 35 a second bus, 36 a third decoding section, 37 a third LSI, and 38 a third DA conversion section.

The first data transfer control section 13 is responsible for data transfer as a device via the first bus 14 of the first LSI 17 and data transfer as a host via the second bus 15 of the first LSI 17. The first and second disk drives 2a and 2b each functioning as a device in the ATA/ATAPI interface are connected to the second bus 15 of the first LSI 17. The second data transfer control section 23 is responsible for data transfer as a device via the first bus 24 of the second LSI 27 and data transfer as a host via the second bus 25 of the second LSI 27. The first bus 14 of the first LSI 17 and the second bus 25 of the second LSI 27 are connected to each other via a first link bus 401. The third data transfer control section 33 is responsible for data transfer as a device via the first bus 34 of the third LSI 37 and data transfer as a host via the second bus 35 of the third LSI 37. The first bus 24 of the second LSI 27 and the second bus 35 of the third LSI 37 are connected to each other via a second link bus 402. In this way, the first, second and third LSIs 17, 27 and 37 are linked in a chain via the first and second link buses 401 and 402.

Hereinafter, an operation in simultaneously recording a first program selected by the first tuner 10, a second program selected by the second tuner 20 and a third program selected by the third tuner 30 onto the first disk drive 2a will be described. Note that description on playback operation will be omitted.

First, recording of the first program will be described. The first data transfer control section 13 instructs the first encoding section 12 to execute encoding, and once receiving video/audio data corresponding to the first program generated by the first encoding section 12, transmits a control command directing to record the first program onto the first disk drive 2a, together with the video/audio data corresponding to the first program, to the second bus 15. Once receiving the control command directing to record the first program onto the first disk drive 2a, the first disk drive 2a records the received video/audio data corresponding to the first program on the hard disk.

Next, recording of the second program will be described. The second data transfer control section 23 instructs the second encoding section 22 to execute encoding, and once receiving video/audio data corresponding to the second program generated by the second encoding section 22, transmits a control command directing to record the second program onto the first disk drive 2a, together with the video/audio data corresponding to the second program, to the first link bus 401. Once receiving the control command directing to record the second program onto the first disk drive 2a, the first data transfer control section 13 transmits a control command directing to record the second program onto the first disk drive 2a, together with the received video/audio data corresponding to the second program, to the second bus 15. Once receiving the control command directing to record the second program onto the first disk drive 2a, the first disk drive 2a records the received video/audio data corresponding to the second program on the hard disk.

Finally, recording of the third program will be described. The third data transfer control section 33 instructs the third encoding section 32 to execute encoding, and once receiving video/audio data corresponding to the third program generated by the third encoding section 32, transmits a control command directing to record the third program onto the first disk drive 2a, together with the video/audio data corresponding to the third program, to the second link bus 402. Once receiving the control command directing to record the third program onto the first disk drive 2a, the second data transfer control section 23 transmits a control command directing to record the third program onto the first disk drive 2a, together with the received video/audio data corresponding to the third program, to the first link bus 401. Once receiving the control command directing to record the third program onto the first disk drive 2a, the first data transfer control section 13 transmits a control command directing to record the third program onto the first disk drive 2a, together with the received video/audio data corresponding to the third program, to the second bus 15. Once receiving the control command directing to record the third program onto the first disk drive 2a, the first disk drive 2a records the received video/audio data corresponding to the third program on the hard disk.

As described above, with the configuration of FIG. 1, the first, second and third data transfer control sections 13, 23 and 33 individually issue control commands directing to record video/audio data corresponding to the respective programs onto the first disk drive 2a, to thereby attain 3-program simultaneous recording.

Recording operation onto the second disk drive 2b can also be done in the manner described above. The number of unit circuits linked in a chain can be easily increased or decreased. A disk drive can be additionally placed on either of the first and second link buses 401 and 402.

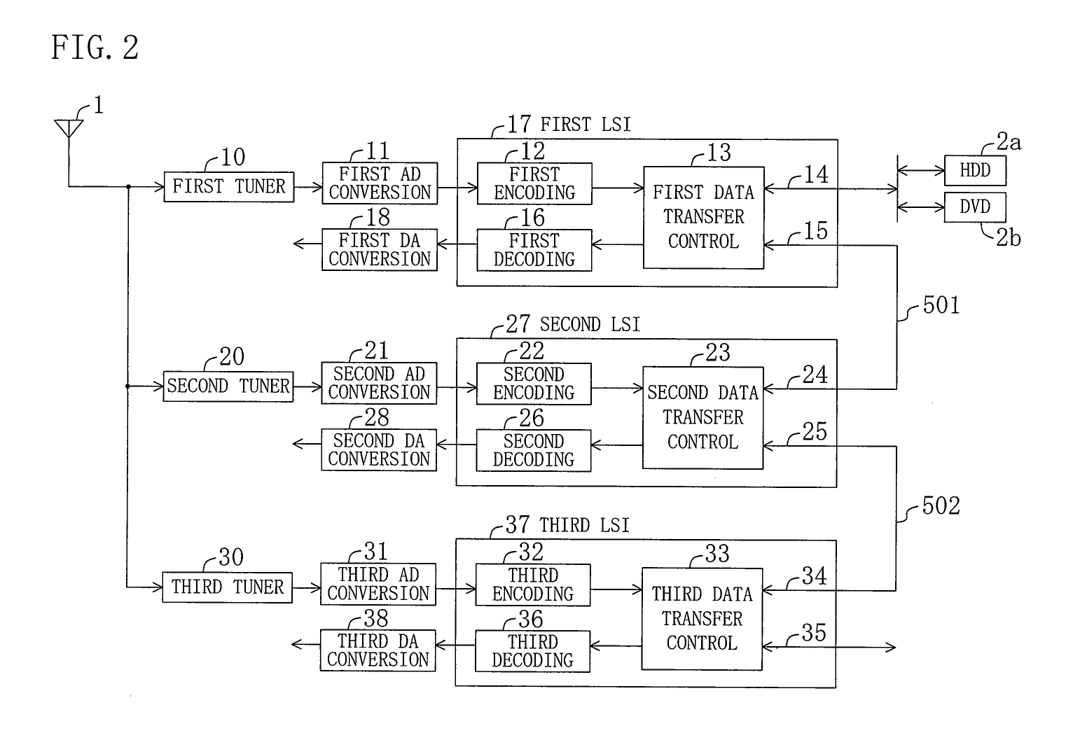

FIG. 2 shows another exemplary configuration of the video/audio recording/playback apparatus of the present invention. The first, second and third unit circuits are the same in configuration as those in FIG. 1. In FIG. 2, however, the first data transfer control section 13 is responsible for data transfer as a host via the first bus 14 of the first LSI 17 and data transfer as a host via the second bus 15 of the first LSI 17. The first and second disk drives 2a and 2b are connected to the first bus 14 of the first LSI 17. The second data transfer control section 23 is responsible for data transfer as a device via the first bus 24 of the second LSI 27 and data transfer as a host via the second bus 25 of the second LSI 27. The second bus 15 of the first LSI 17 and the first bus 24 of the second LSI 27 are connected to each other via a first link bus 501. The third data transfer control section 33 is responsible for data transfer as a device via the first bus 34 of the third LSI 37 and data transfer as a host via the second bus 35 of the third LSI 37. The second bus 25 of the second LSI 27 and the first bus 34 of the third LSI 37 are connected to each other via a second link bus 502. In this way, the first, second and third LSIs 17, 27 and 37 are linked in a chain via the first and second link buses 501 and 502.

Hereinafter, an operation in simultaneously recording a first program selected by the first tuner 10, a second program selected by the second tuner 20 and a third program selected by the third tuner 30 onto the first disk drive 2a will be described. Note that description on playback operation will be omitted.

First, recording of the first program will be described. The first data transfer control section 13 instructs the first encoding section 12 to execute encoding, and once receiving video/audio data corresponding to the first program generated by the first encoding section 12, transmits a control command directing to record the first program onto the first disk drive 2a, together with the video/audio data corresponding to the first program, to the first bus 14. Once receiving the control command directing to record the first program onto the first disk drive 2a, the first disk drive 2a records the received video/audio data corresponding to the first program on the hard disk.

Next, recording of the second program will be described. The first data transfer control section 13 transmits a control command directing to record the second program onto the first disk drive 2a to the first link bus 501. Once receiving the control command directing to record the second program onto the first disk drive 2a, the second data transfer control section 23 instructs the second encoding section 22 to execute encoding, and once receiving video/audio data corresponding to the second program generated by the second encoding section 22, transmits the video/audio data corresponding to the second program to the first link bus 501. Once receiving the video/audio data corresponding to the second program, the first data transfer control section 13 transmits a control command directing to record the second program onto the first disk drive 2a, together with the received video/audio data corresponding to the second program, to the first bus 14. Once receiving the control command directing to record the second program onto the first disk drive 2a, the first disk drive 2a records the received video/audio data corresponding to the second program on the hard disk.

Finally, recording of the third program will be described. The first data transfer control section 13 transmits a control command directing to record the third program onto the first disk drive 2a to the first link bus 501. Once receiving the control command directing to record the third program onto the first disk drive 2a, the second data transfer control section 23 transmits a control command directing to record the third program onto the first disk drive 2a to the second link bus 502. Once receiving the control command directing to record the third program onto the first disk drive 2a, the third data transfer control section 33 instructs the third encoding section 32 to execute encoding, and once receiving video/audio data corresponding to the third program generated by the third encoding section 32, transmits the video/audio data corresponding to the third program to the second link bus 502. Once receiving the video/audio data corresponding to the third program, the second data transfer control section 23 transmits the received video/audio data corresponding to the third program to the first link bus 501. Once receiving the video/audio data corresponding to the third program, the first data transfer control section 13 transmits a control command directing to record the third program onto the first disk drive 2a, together with the received video/audio data corresponding to the third program, to the first bus 14. Once receiving the control command directing to record the third program onto the first disk drive 2a, the first disk drive 2a records the received video/audio data corresponding to the third program on the hard disk.

As described above, with the configuration of FIG. 2, the first transfer control section 13 performs unified management to issue the control commands directing to record video/audio data corresponding to the three programs onto the first disk drive 2a, to thereby attain 3-program simultaneous recording. That is, the configuration of FIG. 2, which permits the single data transfer control section 13 to perform unified management of a plurality of recording/playback operations, will be easier in attainment of the entire control than the configuration of FIG. 1.

Recording onto the second disk drive 2b can also be done in the manner described above. The number of unit circuits linked in a chain can be easily increased or decreased. A disk drive can be additionally placed on either of the first and second link buses 501 and 502 and on the second bus 35 of the third LSI 37.

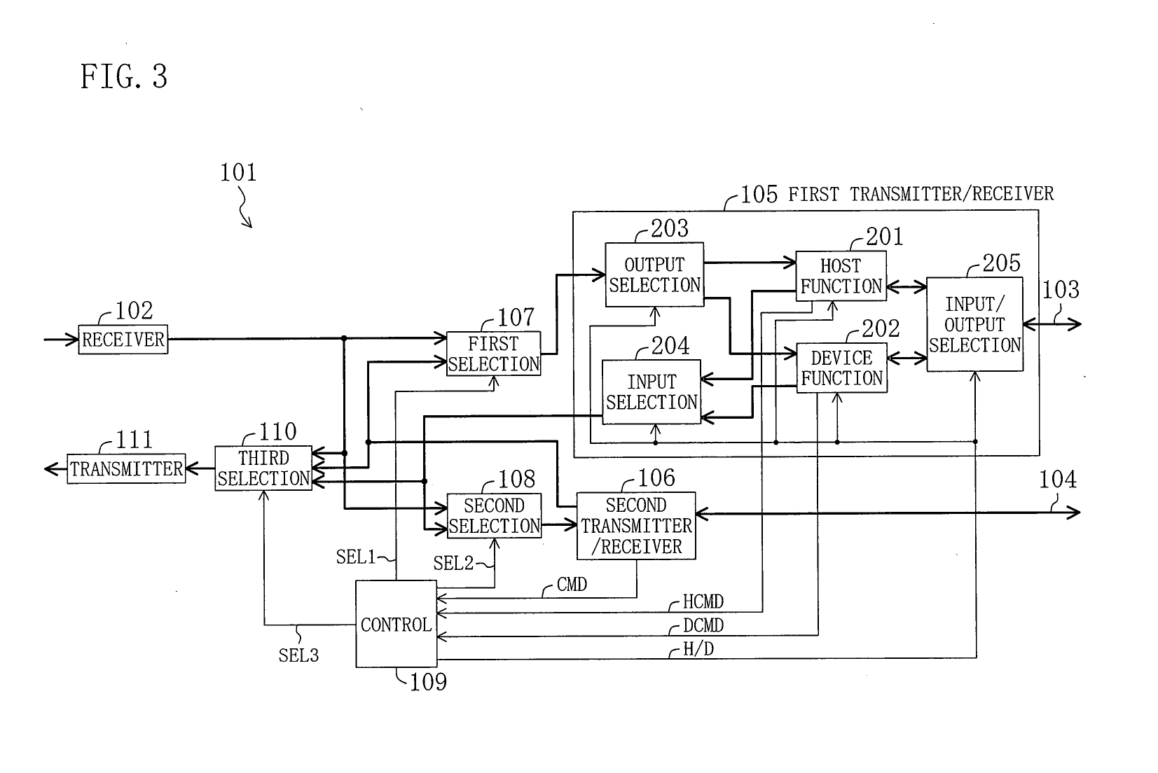

FIG. 3 shows a detailed exemplary configuration of the first, second and third data transfer control sections 13, 23 and 33 in FIGS. 1 and 2. A data transfer control section 101 of FIG. 3 includes a receiver part 102, a first bus 103, a second bus 104, a first transmitter/receiver part 105, a second transmitter/receiver part 106, a first selection part 107, a second selection part 108, a control part 109, a third selection part 110 and a transmitter part 111. The first bus 103 in FIG. 3 corresponds to the first bus 14, 24 or 34 in FIGS. 1 and 2, and the second bus 104 in FIG. 3 corresponds to the second bus 15, 25 or 35 in FIGS. 1 and 2.

The receiver part 102 receives video/audio data from the first, second or third encoding section 12, 22 or 32. The first transmitter/receiver part 105 has a function of transmitting video/audio data received from the first bus 103 to the second and third selection parts 108 and 110, and a function of transmitting video/audio data received from the first selection part 107 to the first bus 103, to take charge of transfer of video/audio data as a host or device via the first bus 103. The second transmitter/receiver part 106 has a function of transmitting video/audio data received from the second bus 104 to the first and third selection parts 107 and 110, and a function of transmitting video/audio data received from the second selection part 108 to the second bus 104, to take charge of transfer of video/audio data as a host via the second bus 104. The first selection part 107 selects either one of video/audio data from the receiver part 102 and video/audio data received from the second bus 104 via the second transmitter/receiver part 106, and outputs the selected data to the first transmitter/receiver part 105. The second selection part 108 selects either one of video/audio data from the receiver part 102 and video/audio data received from the first bus 103 via the first transmitter/receiver part 105, and outputs the selected data to the second transmitter/receiver part 106. The third selection part 110 selects any one of video/audio data from the receiver section 102, video/audio data received from the first bus 103 via the first transmitter/receiver part 105 and video/audio data received from the second bus 104 via the second transmitter/receiver part 106, and outputs the selected data to the transmitter part 111. The control part 109 controls the selections of video/audio data in the first, second and third selection parts 107, 108 and 110 with first, second and third selection signals SEL1, SEL2 and SEL3, respectively. The transmitter part 111 transmits video/audio data to the first, second or third decoding section 16, 26 or 36.

The first transmitter/receiver part 105 includes a host function portion 201, a device function portion 202, an output selection portion 203, an input selection portion 204 and an input/output selection portion 205. The host function portion 201 is responsible for transfer of video/audio data as a host via the first bus 103, and supplies a host control command HCMD to the control part 109. The device function portion 202 is responsible for transfer of video/audio data as a device via the first bus 103, and supplies a device control command DCMD to the control part 109. The output selection portion 203 selects to which portion, the host function portion 201 or the device function portion 202, video/audio data received from the first selection part 107 should be outputted. The input selection portion 204 selects which data, video/audio data received from the host function portion 201 or video/audio data received from the device function portion 202, should be outputted to the second and third selection parts 108 and 110. The input/output selection portion 205 selects which portion, the host function portion 201 or the device function portion 202, should be connected to the first bus 103. The control part 109 outputs a host/device designation signal H/D to the first transmitter/receiver part 105 so as to designate which portion, the host function portion 201 or the device function portion 202, should be made valid and also control the selections in the output selection portion 203, the input selection portion 204 and the input/output selection portion 205. The control part 109 receives the host control command HCMD or the device control command DCMD, and also receives a control command CMD supplied from the second transmitter/receiver part 106.

When the data transfer control section 101 of FIG. 3 is used as the first data transfer control section 13 in FIG. 2, the host function portion 201 is set valid while the device function portion 202 is set invalid with the host/device designation signal H/D. In this case, the output selection portion 203 outputs video/audio data received from the first selection part 107 to the host function portion 201, and the input selection portion 204 transmits video/audio data received from the host function portion 201 to the second and third selection parts 108 and 110. Also, the input/output selection portion 205 connects the host function portion 201 to the first bus 103. In this way, the first transmitter/receiver part 105 takes charge of transfer of video/audio data as a host via the first bus 103. The host function portion 201 supplies the host control command HCMD to the control part 109 so as to generate the first selection signal SEL1, for example. The host function portion 201 then receives video/audio data of a given program via the first selection part 107, and transmits a control command directing to record the video/audio data onto the first disk drive 2a or the second disk drive 2b, together with the video/audio data, to the first bus 103.

When the data transfer control section 101 of FIG. 3 is used as the first, second or third data transfer control section 13, 23 or 33 in FIG. 1 or the second or third data transfer control section 23 or 33 in FIG. 2, the device function portion 202 is set valid while the host function portion 201 is set invalid with the host/device designation signal H/D. In this case, the output selection portion 203 outputs video/audio data received from the first selection part 107 to the device function portion 202, and the input selection portion 204 transmits video/audio data received from the device function portion 202 to the second and third selection parts 108 and 110. Also, the input/output selection portion 205 connects the device function portion 202 to the first bus 103. In this way, the first transmitter/receiver part 105 takes charge of transfer of video/audio data as a device via the first bus 103. The device function portion 202 analyzes a control command received via the first bus 103, and based on the nature of the control command, supplies the device control command DCMD to the control part 109 so as to generate the second selection signal SEL2, for example, to thereby control so that video/audio data received via the first bus 103 be transmitted to the second bus 104 via the second selection part 108 and the second transmitter/receiver part 106.

The second transmitter/receiver part 106 is responsible for transfer of video/audio data as a host via the second bus 104. Alternatively, the second transmitter/receiver part 106 may have an internal configuration similar to that of the first transmitter/receiver part 105 permitting switching between the host function and the device function. When only the LSI linking in FIG. 1 is adopted disregarding the LSI linking in FIG. 2, the configuration of the data transfer control section 101 can be simplified so that the first transmitter/receiver part 105 has only the device function while the second transmitter/receiver part 106 has only the host function.

As described above, having the configurations of FIGS. 1 to 3, it is possible to attain 3-program simultaneous recording by linking the first, second and third LSIs 17, 27 and 37 having the same internal configuration in a chain. The number of LSIs linked in a chain can be freely increased or decreased. Even a single LSI having the one-program recording function is highly useful.

In the market of DVD recorders, while inexpensive apparatuses having the one-program recording function are needed as popular models, middle- to high-class models require the function of recording a plurality of programs simultaneously. According to the present invention, the same LSIs can be provided for both popular models and middle- to high-class models. Also, the same LSIs can be shared among a plurality of models. This permits a long life cycle of the LSIs and also effective use of software resources.

The AD conversion section and/or the DA conversion section may be incorporated in each LSI, and further the tuner may be incorporated in each LSI.

Either one of the first and second disk drives 2a and 2b in FIGS. 1 and 2 may be omitted. Otherwise, the number of disk drives may be increased, as described above, as long as it does not exceed the constraint in the number of devices connected. The connected disk drive or drives may be any of a magnetic disk drive, an optical disk drive and the like.

### INDUSTRIAL APPLICABILITY

As described above, the video/audio recording/playback apparatus of the present invention, in which a plurality of unit circuits each having one-program recording function are linked in a chain, can easily increase the number of programs that can be recorded simultaneously, and thus is useful as a DVD recorder and the like.

1. A video/audio recording/playback apparatus comprising a disk drive for recording video/audio data and a plurality of unit circuits,
each of the plurality of unit circuits comprising:
first and second buses for transfer of video/audio data;
an encoding section for encoding a video/audio signal to video/audio data;
a decoding section for decoding video/audio data to a video/audio signal; and
a data transfer control section responsible for reception of video/audio data from the encoding section, transmission of video/audio data to the decoding section, transfer of video/audio data using the first bus, and transfer of video/audio data using the second bus,
wherein, to link the plurality of unit circuits in a chain, the first bus of one of two unit circuits adjacent to each other is linked to the second bus of the other unit circuit, and
the disk drive is connected to one of the first and second buses of the plurality of unit circuits.

2. The video/audio recording/playback apparatus of claim 1, wherein the data transfer control section comprises:
a receiver part for receiving video/audio data from the encoding section;
a transmitter part for transmitting video/audio data to the decoding section;
a first transmitter/receiver part responsible for transfer of video/audio data using the first bus;
a second transmitter/receiver part responsible for transfer of video/audio data using the second bus;
a first selection part for selecting one of video/audio data from the receiver part and video/audio data received from the second bus via the second transmitter/receiver part, and transmitting the selected data to the first transmitter/receiver part;
a second selection part for selecting one of video/audio data from the receiver part and video/audio data received from the first bus via the first transmitter/receiver part, and transmitting the selected data to the second transmitter/receiver part;
a third selection part for selecting one of video/audio data from the receiver part, video/audio data received from the first bus via the first transmitter/receiver part and video/audio data received from the second bus via the second transmitter/receiver part, and transmitting the selected data to the transmitter part; and
a control part for controlling the selection of video/audio data in the first, second and third selection parts,
wherein the first transmitter/receiver part has a function of transmitting video/audio data received from the first bus to the second and third selection parts and a function of transmitting video/audio data received from the first selection part to the first bus, and
the second transmitter/receiver part has a function of transmitting video/audio data received from the second bus to the first and third selection parts and a function of transmitting video/audio data received from the second selection part to the second bus.

3. The video/audio recording/playback apparatus of claim 2, wherein the first and second buses are ATA/ATAPI (AT Attachment with Packet Interface) interface buses,
the second transmitter/receiver part has a function responsible for transfer of video/audio data as a host via the second bus,
the first transmitter/receiver part comprises:
a host function portion responsible for transfer of video/audio data as a host via the first bus;
a device function portion responsible for transfer of video/audio data as a device via the first bus;
an output selection portion for selecting to which portion, the host function portion or the device function portion, video/audio data received from the first selection part should be outputted;
an input selection portion for selecting which data, video/audio data received from the host function portion or video/audio data received from the device function portion, should be transmitted to the second and third selection parts; and
an input/output selection portion for selecting which portion, the host function portion or the device function portion, should be connected to the first bus, and
the control part outputs a signal designating which portion, the host function portion or the device function portion, should be made valid, and further has a function of controlling the selections in the output selection portion, the input selection portion and the input/output selection portion.

4. The video/audio recording/playback apparatus of claim 3, wherein the disk drive is connected to the second bus of a unit circuit located at an end, among the plurality of unit circuits linked in a chain, which is not used for linking between the plurality of unit circuits,
in the plurality of unit circuits, the device function portions of all the first transmitter/receiver parts are set valid while the host function portions thereof are set invalid, and
the data transfer control section of each of the plurality of unit circuits is allowed to individually issue a control command directing to record video/audio data of a program corresponding to the unit circuit onto the disk drive.

5. The video/audio recording/playback apparatus of claim 3, wherein the disk drive is connected to the first bus of a unit circuit located at an end, among the plurality of unit circuits linked in a chain, which is not used for linking between the plurality of unit circuits,
in the unit circuit connected with the drive disk, the host function portion of the first transmitter/receiver part is set valid while the device function portion thereof is set invalid,
in the other unit circuits, the device function portions of all the first transmitter/receiver parts are set valid while the host function portions thereof are set invalid, and
the data transfer control section of the unit circuit connected with the disk drive is allowed to issue a plurality of control commands directing to record video/audio data of respective programs corresponding to the plurality of unit circuits onto the disk drive.

6. The video/audio recording/playback apparatus of claim 1, wherein each of the plurality of unit circuits further comprises:
a tuner for selecting a specific program and outputting an analog video/audio signal;
an analog-to-digital conversion section for converting the analog video/audio signal from the tuner to a digital video/audio signal and outputting the converted signal to the encoding section; and
a digital-to-analog conversion section for converting a digital video/audio signal from the decoding section to an analog video/audio signal.
